(19) United States
(12) Patent Application Publication
(10) Pub. No.: US 2014/0316675 A1
(43) Pub. Date: Oct. 23, 2014

(54) PRESERVING COMBUSTION STABILITY DURING COMPRESSOR-SURGE CONDITIONS

(71) Applicant: FORD GLOBAL TECHNOLOGIES, LLC, Dearborn, MI (US)

(72) Inventors: Julia Helen Buckland, Commerce Township, MI (US); Matthew John Gerhart, Dearborn Heights, MI (US); Suzanne Kay Wait, Royal Oak, MI (US); Timothy Joseph Clark, Livonia, MI (US); Gopichandra Surnilla, West Bloomfield, MI (US); James Alfred Hilditch, Canton, MI (US); Todd Anthony Rumpsa, Saline, MI (US)

(73) Assignee: Ford Global Technologies, LLC, Dearborn, MI (US)

(21) Appl. No.: 13/865,815

(22) Filed: Apr. 18, 2013

(51) Int. Cl. F02D 41/00; F02B 37/12

(52) U.S. Cl. CPC F02D 41/0052; F02D 41/0007; F02D 41/0077; F02B 37/12
USPC 701/103; 123/568.21; 123/568.15; 123/559.1; 60/605.2; 60/602

(57) ABSTRACT

A method to avoid over-dilution of an intake-air charge of an engine includes, during a first condition, applying at least some feedback control to the opening and closure of a valve that adjustably admits exhaust to the intake-air charge. During a second condition predictive of compressor surge, no feedback control is applied to the opening or the closure of the valve. Rather, feedforward control is applied to the closure of the valve so that stability in the engine is maintained even during surge conditions.

### TECHNICAL FIELD

This application relates to the field of motor vehicle engineering, and more particularly, to avoidance of over-dilution of an intake-air charge of an engine.

### BACKGROUND AND SUMMARY

A boosted engine may provide better fuel economy than a naturally aspirated engine of similar output power. However, boosting may result in undesirably high combustion temperatures in the engine. Exhaust-gas recirculation (EGR) may be used to remedy this issue and to provide other benefits. In gasoline engines, for example, cooled EGR can improve fuel economy. At medium and high loads, fuel economy is improved due to knock mitigation, allowing for more efficient combustion phasing, reduced heat loss to the engine coolant, and lower exhaust temperatures—which in turn reduce the need for enrichment to cool the exhaust components. At low loads, EGR provides an additional benefit of reducing throttling losses.

In boosted engine systems equipped with an intake-air compressor coupled to an exhaust-driven turbine, exhaust gas may be recirculated through a high pressure (HP) EGR loop and/or a low-pressure (LP) EGR loop. In an LP EGR loop, the exhaust gas is taken from downstream of the turbine and is mixed with intake air upstream of the compressor. In contrast to HP EGR, where the exhaust gas is taken from upstream of the turbine and delivered downstream of the compressor, LP EGR provides adequate flow from mid to high engine loads, is more easily cooled, and can be controlled more independently of the throttle and waste gate.

With LP EGR, the dilution rate is determined by the pressure at the compressor inlet and by the mass flow rate through the compressor. An issue with boosted engines is that the compressor may surge when the mass flow rate becomes too low for the current level of boost. The inventors herein have observed that during compressor surge, pressure and flow oscillations across the air-induction system (AIS) of the engine may cause the dilution rate to oscillate as well. In gasoline-engine systems, oscillations in dilution rate may result in combustion instability—i.e., when too little oxygen is supplied to engine. Moreover, state-of-the-art feedback control of the LP EGR dilution rate may amplify the oscillations, resulting in sustained combustion instability, with a noticeable effect on drivability. In diesel-engine systems, oscillations in dilution rate may erode the emissions-control benefits of EGR.

Accordingly, one embodiment of this disclosure provides a method to avoid over-dilution of an intake-air charge of an engine. In this method, during a first condition, at least some feedback control is applied to the opening and closure of a valve that adjustably admits exhaust gas to the intake-air charge. During a second condition predictive of compressor surge, no feedback control is applied to the opening or the closure of the valve. Rather, feedforward control is applied to the closure of the valve. In this manner, combustion stability in the engine is maintained even during surge conditions.

The statements above are provided to introduce a selected part of this disclosure in simplified form, not to identify key or essential features. The claimed subject matter, defined by the claims, is limited neither to the content above nor to implementations that address problems or disadvantages referenced herein.

### BRIEF DESCRIPTION OF THE DRAWINGS

FIGS. 1 and 2 show aspects of example engine systems in accordance with embodiments of this disclosure.

FIG. 3 is a graph of the outlet-to-inlet pressure ratio of an example compressor versus the corrected mass air-flow rate through the compressor in accordance with an embodiment of this disclosure.

FIG. 4 illustrates an example method to avoid over-dilution of an intake-air charge of an engine in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

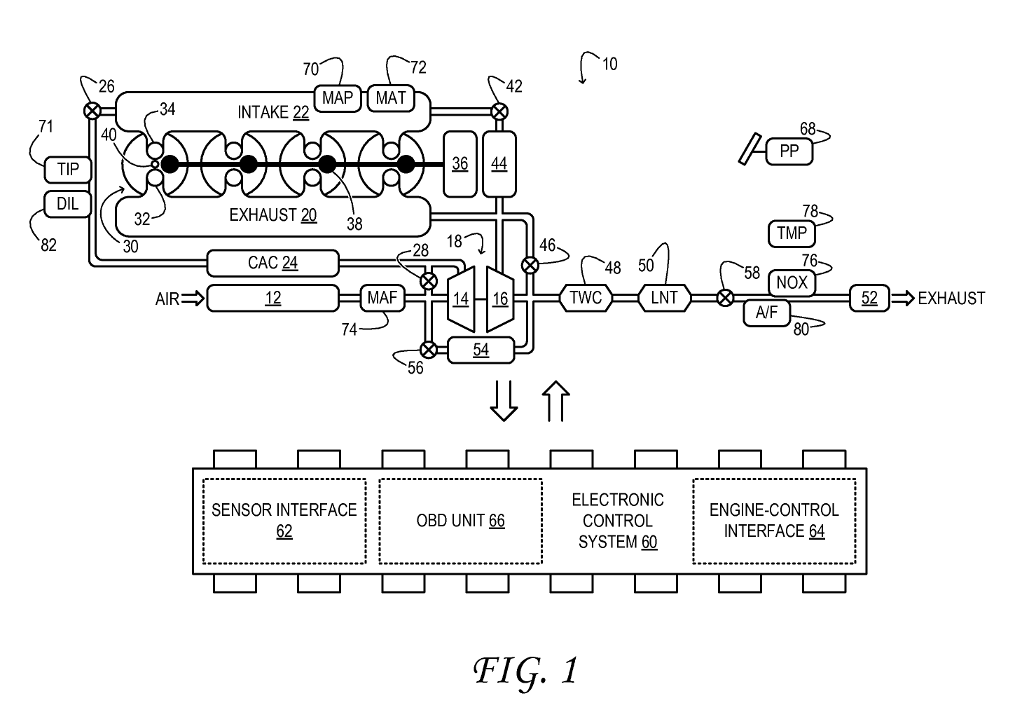

FIG. 1 schematically shows aspects of an example engine system 10 of a motor vehicle. In engine system 10, fresh air is inducted into air cleaner 12 and flows to compressor 14. The compressor may be any suitable intake-air compressor—a motor-driven or driveshaft driven supercharger compressor, for example. In engine system 10, however, the compressor is mechanically coupled to turbine 16 in turbocharger 18, the turbine driven by expanding engine exhaust from exhaust manifold 20.

Compressor 14 is coupled fluidically to intake manifold 22 via charge-air cooler (CAC) 24 and throttle valve 26. Pressurized air from the compressor flows through the CAC and the throttle valve en route to the intake manifold. In the illustrated embodiment, compressor recirculation valve (CRV) 28 is coupled between the inlet and the outlet of the compressor. The compressor by-pass valve may be a normally closed valve configured to open to relieve excess boost pressure under selected operating conditions.

Exhaust manifold 20 and intake manifold 22 are coupled to a series of cylinders 30 through a series of exhaust valves 32 and intake valves 34, respectively. In one embodiment, the exhaust and/or intake valves may be electronically actuated. In another embodiment, the exhaust and/or intake valves may be cam actuated. Whether electronically actuated or cam actuated, the timing of exhaust and intake valve opening and closure may be adjusted as needed for desired combustion and emissions-control performance.

Cylinders 30 may be supplied any of a variety of fuels, depending on the embodiment: gasoline, alcohols, or mixtures thereof. In the illustrated embodiment, fuel from fuel system 36 is supplied to the cylinders via direct injection through fuel injectors 38. In the various embodiments considered herein, the fuel may be supplied via direct injection, port injection, throttle-body injection, or any combination thereof. In engine system 10, combustion is initiated via spark ignition at spark plugs 40. The spark plugs are driven by timed high-voltage pulses from an electronic ignition unit (not shown in the drawings).

Engine system 10 includes high-pressure (HP) exhaust-gas recirculation (EGR) valve 42 and HP EGR cooler 44. When the HP EGR valve is opened, some high-pressure exhaust from exhaust manifold 20 is drawn through the HP EGR cooler to intake manifold 22. In the intake manifold, the high pressure exhaust dilutes the intake-air charge for cooler combustion temperatures, decreased emissions, and other benefits. The remaining exhaust flows to turbine 16 to drive the turbine. When reduced turbine torque is desired, some or all of the exhaust may be directed instead through wastegate 46, by-passing the turbine. The combined flow from the turbine and the wastegate then flows through the various exhaust-aftertreatment devices of the engine system, as further described below.

In engine system 10, three-way catalyst (TWC) device 48 is coupled downstream of turbine 16. The TWC device includes an internal catalyst-support structure to which a catalytic washcoat is applied. The washcoat is configured to oxidize residual CO, hydrogen, and hydrocarbons and to reduce nitrogen oxides (NOₓ) present in the engine exhaust. Lean NOₓ trap (LNT) 50 is coupled downstream of TWC device 48. The LNT is configured to trap NOₓ from the exhaust flow when the exhaust flow is lean, and to reduce the trapped NOₓ when the exhaust flow is rich.

It will be noted that the nature, number, and arrangement of exhaust-aftertreatment devices in the engine system may differ for the different embodiments of this disclosure. For instance, some configurations may include an additional soot filter or a multi-purpose exhaust-aftertreatment device that combines soot filtering with other emissions-control functions, such as NOₓ trapping.

Continuing in FIG. 1, all or part of the treated exhaust may be released into the ambient via silencer 52. Depending on operating conditions, however, some exhaust may be diverted through low-pressure (LP) EGR cooler 54, before or after emissions-control treatment. The exhaust may be diverted by opening LP EGR valve 56 coupled in series with the LP EGR cooler. From LP EGR cooler 54, the cooled exhaust gas flows to compressor 14. By partially closing exhaust-backpressure valve 58, the flow potential for LP EGR may be increased during selected operating conditions. Other configurations may include an AIS throttle valve arranged downstream of air cleaner 12 but upstream of LP EGR entry.

Engine system 10 includes electronic control system 60 configured to control various engine-system functions. The electronic control system includes memory and one or more processors configured for appropriate decision making responsive to sensor input and directed to intelligent control of engine-system componentry. Such decision-making may be enacted according to various strategies such as event-driven, interrupt-driven, multi-tasking, multi-threading, and the like. In this manner, the electronic control system may be configured to enact any or all aspects of the methods disclosed hereinafter. Accordingly, the method steps disclosed hereinafter—e.g., operations, functions, and/or acts—may be embodied as code programmed into machine-readable storage media in the electronic control system. In this manner, the electronic control system may be configured to enact any or all aspects of the methods disclosed herein, wherein the various method steps—e.g., operations, functions, and acts—may be embodied as code programmed into machine-readable storage media in the electronic control system.

Electronic control system 60 includes sensor interface 62, engine-control interface 64, and on-board diagnostic (OBD) unit 66. To assess operating conditions of engine system 10 and of the vehicle in which the engine system is installed, sensor interface 62 receives input from various sensors arranged in the vehicle—flow sensors, temperature sensors, pedal-position sensors, pressure sensors, etc. Some example sensors are shown in FIG. 1—accelerator pedal position sensor 68, manifold air-pressure (MAP) sensor 70, throttle inlet pressure (TIP) sensor 71, manifold air-temperature sensor (MAT) 72, mass air-flow (MAF) rate sensor 74, NOₓ sensor 76, exhaust-system temperature sensor 78, exhaust air-to-fuel ratio sensor 80, and intake-air dilution sensor 82. Various other sensors may be provided as well.

Electronic control system 60 also includes engine-control interface 64. The engine-control interface is configured to actuate electronically controllable valves, actuators, and other componentry of the vehicle—throttle valve 26, compressor by-pass valve 28, wastegate 46, and EGR valves 42 and 56, for example. The engine-control interface is operatively coupled to each electronically controlled valve and actuator and is configured to command its opening, closure, and/or adjustment as needed to enact the control functions described herein.

Electronic control system 60 also includes on-board diagnostic (OBD) unit 66. The OBD unit is a portion of the electronic control system configured to diagnose degradation of various components of engine system 10. Such components may include oxygen sensors, fuel injectors, and emissions-control components, as examples.

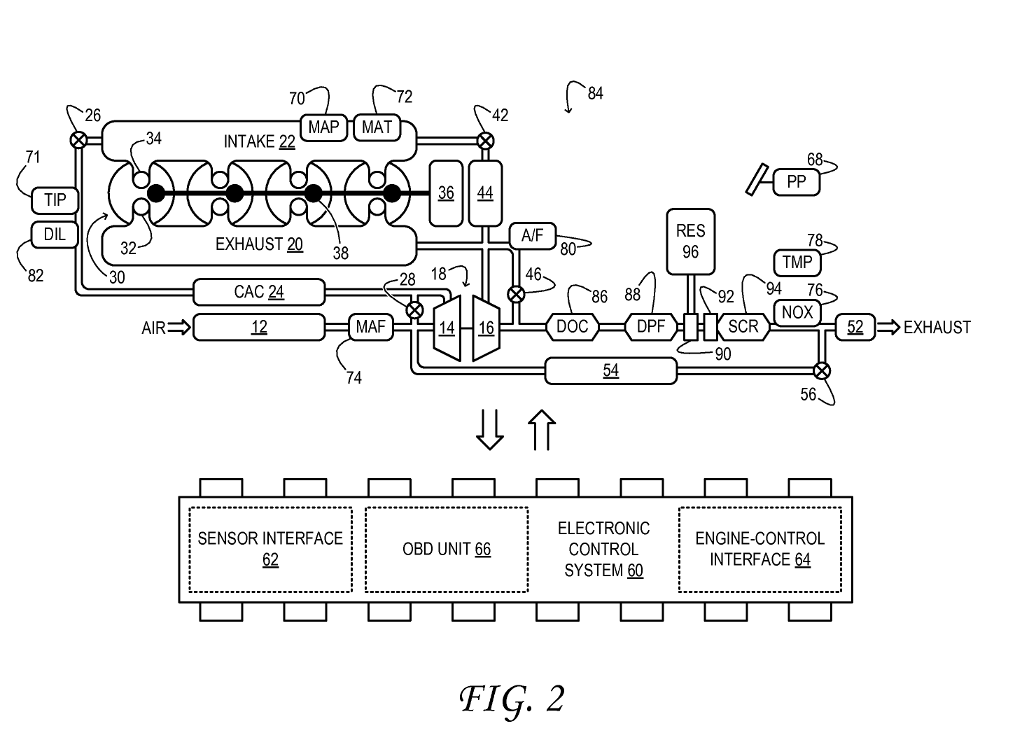

FIG. 2 shows aspects of another engine system 84—adiesel engine in which combustion is initiated via compression ignition. Accordingly, cylinders 30 of engine system 84 are supplied diesel fuel, biodiesel, etc., from fuel system 36. In engine system 84, diesel-oxidation catalyst (DOC) device 86 is coupled downstream of turbine 16. The DOC device includes an internal catalyst-support structure to which a DOC washcoat is applied. The DOC device is configured to oxidize residual CO, hydrogen, and hydrocarbons present in the engine exhaust.

Diesel particulate filter (DPF) 88 is coupled downstream of DOC device 86. The DPF is a regenerable soot filter configured to trap soot entrained in the engine exhaust flow; it comprises a soot-filtering substrate. Applied to the substrate is a washcoat that promotes oxidation of the accumulated soot and recovery of filter capacity under certain conditions. In one embodiment, the accumulated soot may be subject to intermittent oxidizing conditions in which engine function is adjusted to temporarily provide higher-temperature exhaust. In another embodiment, the accumulated soot may be oxidized continuously or quasi-continuously during normal operating conditions.

Reductant injector 90, reductant mixer 92, and SCR device 94 are coupled downstream of DPF 88 in engine system 84. The reductant injector is configured to receive a reductant (e.g., a urea solution) from reductant reservoir 96 and to controllably inject the reductant into the exhaust flow. The reductant injector may include a nozzle that disperses the reductant solution in the form of an aerosol. Arranged downstream of the reductant injector, the reductant mixer is configured to increase the extent and/or homogeneity of the dispersion of the injected reductant in the exhaust flow. The reductant mixer may include one or more vanes configured to swirl the exhaust flow and entrained reductant to improve the dispersion. Upon being dispersed in the hot engine exhaust, at least some of the injected reductant may decompose. In embodiments where the reductant is a urea solution, the reductant will decompose into water, ammonia, and carbon dioxide. The remaining urea decomposes on impact with the SCR catalyst (vide infra).

SCR device 94 is coupled downstream of reductant mixer 92. The SCR device may be configured to facilitate one or more chemical reactions between ammonia formed by the decomposition of the injected reductant and NOₓ from the engine exhaust, thereby reducing the amount of NOₓ released into the ambient. The SCR device comprises an internal catalyst-support structure to which an SCR washcoat is applied. The SCR washcoat is configured to sorb the NOₓ and the ammonia, and to catalyze the redox reaction of the same to form dinitrogen (N₂) and water.

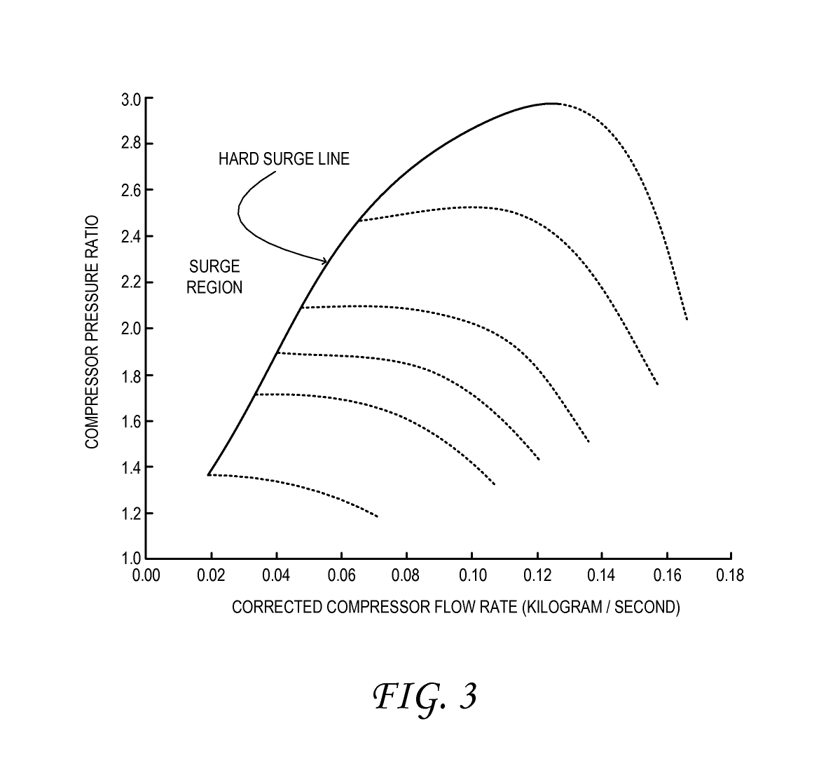

FIG. 3 is a graph of the outlet-to-inlet pressure ratio of example compressor 14 versus the corrected mass air-flow rate through the compressor. The dashed lines on the graph represent various stable operating states of the compressor, while the solid represents the so-called ‘hard surge line’. In operating states to the left and above this line—i.e., at lower flow rates or higher pressure ratios—the compressor is liable to enter a surge condition. Accordingly, the tendency of the compressor to surge may be predicted in electronic control system 60 for given compressor flow and exit pressure conditions. MAF and TIP sensors may be used to measure and/or estimate these conditions. In some embodiments, an accelerator pedal-position sensor may be used to forecast future MAF.

As noted above, electronic control system 60 may exert control over EGR valves 42, 56, or any electronically controlled valve coupled between an exhaust conduit and an air intake and configured to adjustably admit exhaust to the air intake. Further, the manner of control exerted over any such valve may depend on conditions. During a first, normal condition—i.e., a condition not predictive of compressor surge—the controller may be configured to apply at least some feedback control over opening and closure of the valve. During a second condition that is predictive of compressor surge, the controller may be configured to apply no feedback control over the opening or the closure of the valve but to apply feedforward control over the closure of the valve.

In general, the feedback control exerted over the valve during the first condition may be based on an output of intake-air dilution sensor 82 or of an exhaust air-to-fuel ratio sensor 80 operatively coupled to the electronic control system 60. To illustrate, in the embodiment where an intake-air dilution sensor is used, the sensor may output a signal proportional to the partial pressure O of oxygen in the intake air. This signal is compared to a set-point partial pressure O* of oxygen desired for the specific operating conditions of the engine—e.g., speed and load. Let δ=O−O*. The particular feedback control exerted on the opening extent E of EGR valve 56 may take the form

$$E = P δ + I {\int }_{0}^{T} δ d t + D \frac{d δ}{d T} , \qquad ( 1 )$$

where Tand t represent the time, and P, I, and D are optimized constants. In some (e.g., diesel) engine configurations, output from an exhaust air-to-fuel ratio sensor may indirectly report the extent of intake-air dilution when the fuel-injection rate is taken into account. Accordingly, a dedicated intake-air dilution sensor may be omitted in some embodiments.

In some embodiments, the first and second conditions referred to hereinabove may be distinguished based on the output of engine-system sensors operatively coupled to the controller. For example, the first condition may be a condition in which a combined output of pedal-position sensor 68 and the TIP sensor 71 does not predict compressor surge. By contrast, the second condition may be a condition in which the combined output of the pedal position sensor and the TIP sensor does predict compressor surge. In this embodiment, which is in no way limiting, the TIP sensor output corresponds to the actual, current pressure ratio at the time of measurement, while the pedal-position sensor output is used to estimate the MAF at a future time. In certain embodiments applicable to diesel-engine systems, a MAP sensor may be used in place of the TIP sensor referred to herein. In still other embodiments, different combinations of sensor outputs may be used to determine whether compressor surge is or is not predicted.

The configurations described above enable various methods to avoid over-dilution of an intake-air charge of an engine. Accordingly, some such methods are now described, by way of example, with continued reference to the above configurations. It will be understood, however, that the methods here described, and others within the scope of this disclosure, may be enabled by different configurations as well. The methods may be entered upon any time systems 10 or 84 are operating, and may be executed repeatedly. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

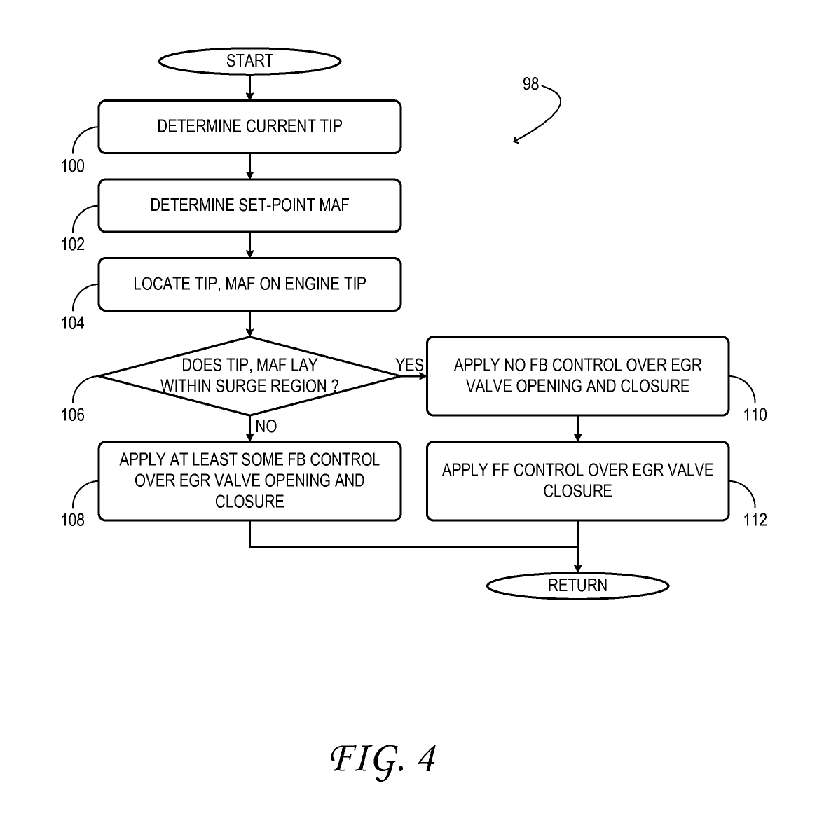

FIG. 4 illustrates an example method 98 to avoid over-dilution of an intake-air charge of an engine in one embodiment. At 100 of method 98, the current MAP is determined. More specifically, electronic control system 60 receives a first data stream responsive to the current boost pressure being generated by compressor 14. In one embodiment, the first data stream may be received from TIP sensor 71, which is coupled to the engine downstream of compressor 14.

At 102 of method 98 the set-point MAF rate for the engine is determined. More specifically, electronic control system 60 receives a second data stream responsive to the set-point mass flow rate of air through the compressor. In one embodiment, the second data stream may be received from an accelerator-pedal position sensor 68 of the vehicle in which the engine is installed. As noted above, the pedal-position sensor output may correspond to a future MAF rate, rather than the current MAF rate.

At 104 of method 98, the operating state corresponding to the received TIP and set-point MAF is located on an engine map stored within electronic control system 60. At 106 it is determined whether the received TIP and set-point MAF from the first and second data streams lie outside or within a surge region of compressor 14. In other words, it is determined whether or not the data correspond to a condition predictive of compressor surge. In some embodiments, the data may be referenced against the hard surge line (as shown in FIG. 3). In other embodiments, the line used for comparison may be shifted to the right to provide a more conservative prediction of surge. Accordingly, the term ‘surge region’ as used herein, should not be limited necessarily to the region identified in FIG. 3, but may also include at least some operating states marginally to the right of the hard surge line.

If the received TIP and set-point MAF lie outside the surge region of the compressor, then the method advances to 108, where at least some feedback control is applied over the opening and closure of a valve that adjustably admits exhaust to the air intake—EGR valves 42 and/or 56, for example. In one embodiment, the feedback control may be based on an output of an intake-air dilution sensor or an exhaust air-to-fuel ratio sensor, as noted above. Accordingly, method 98 may optionally include the action of receiving a third data stream from any such sensor. In this and other embodiments, the feedback control applied at this stage of execution may include control of a position of the EGR valve as a sum of feedback terms. The feedback terms may be substantially as shown above, in equation 1. In other words, the EGR valve opening extent may depend on a difference between current and set-point dilution levels of the intake-air charge or of an air-to-fuel ratio of the exhaust—i.e., the P term. In a more particular embodiment, the feedback terms may include a term proportional to the difference and a term proportional to the difference integrated over time—i.e., P and/terms. Optionally, the feedback terms may also include a term proportional to the derivative of the difference with respect to time—i.e., the D term.

Continuing in FIG. 4, if the received TIP and set-point MAF lie within the surge region, then the method advances to 110. At 110 no feedback control over EGR valve opening or closure is applied. Instead, at 112, feedforward control over EGR valve closure is applied. In contrast to feedback control, the feedforward control may include control of a position of the EGR valve as a function of the set-point dilution level of the intake air charge or, for some configurations, the set-point air-to-fuel ratio, irrespective of the current dilution level or current air-to-fuel ratio.

In one embodiment, a prescribed methodology may be enacted on transitioning from a first condition, where surge is not predicted, to a second condition where surge is predicted. During such a transition, the integral feedback term/as computed prior to the transitioning may be frozen. Then, feedforward control may be applied to adjust the valve position resulting from the feedback control with feedback terms frozen. In a more particular embodiment, the feedback may only be applied in a direction to close the valve, not to open it. In this manner, over-dilution of the intake-air charge may be prevented.

As a consequence of method 98 and related methods, one or more EGR valves of the engine system may be less open during the second condition, where surge is predicted, than during the first condition, where surge is not predicted. Accordingly, external exhaust-gas recirculation may be enabled during the first condition and disabled during the second condition.

Another advantage of this approach is that combustion stability may be preserved even at the onset of compressor surge. Accordingly, the various remedies commonly used to stop surge—e.g., opening a CRV or wastegate—need not be applied preemptively (e.g., when surge is merely predicted but not actually detected). Such measures may instead be delayed until the surge is actually detected, or until a stronger predictor of surge (higher TIP or lower MAF) is detected by the electronic control system. In particular, the CRV and/or wastegate of turbocharger 18 may be held closed during the second condition referred to hereinabove. In this manner, the compressed air supply may be maintained across wider operating range, for better performance and fuel economy.

It will be understood that the articles, systems, and methods described hereinabove are embodiments of this disclosure—non-limiting examples for which numerous variations and extensions are contemplated as well. This disclosure also includes all novel and non-obvious combinations and sub-combinations of the above articles, systems, and methods, and any and all equivalents thereof.

As an example of additional and/or alternative approaches, in one embodiment, a method is provided to reduce over-dilution of an intake-air charge of a turbocharged engine carrying out stoichiometric spark-ignited combustion. The method may include during a first condition, applying at least some feedback control of HP and/or LP EGR valve opening degree responsive to desired exhaust air-fuel ratio, desired intake manifold charge dilution, and respective determinations of the actual values. In this first condition, the measurement and/or determination of the actual exhaust air-fuel ratio and intake manifold charge dilution, compared with the desired values, generate adjustments to the EGR valve opening degree so that the opening degree is adjusted during operation responsive to real-time feedback of operating parameters. During second, different condition from the first condition, the method still continues to adjust the degree of opening of the EGR valve as the engine operates and carries out combustion with at least some EGR flowing, but the adjustment is made independent of the estimation and/or measurement of the operating parameters used to provide feedback during the first condition. For example, the differences between desired and actual/determined values used during the first condition is not used to adjust the EGR valve opening degree during the second condition. Instead, during the second condition, the EGR valve opening degree may be adjusted based on feedforward control, with the second condition predictive of compressor surge, including actual surge being detected. The feedforward control thus breaks a link between EGR valve position and measured/determined exhaust air-fuel ratio and/or intake manifold charge dilution (such as indicated by an intake manifold oxygen sensor). Therefore, even though these parameters may be changing during the second condition, the desired EGR valve opening degree is not changed responsive thereto.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method to avoid over-dilution of an intake-air charge of an engine, the method comprising:
during a first condition, applying at least some feedback control over opening and closure of a valve that adjustably admits exhaust to the intake-air charge; and
during a second condition, applying no feedback control over the opening or the closure of the valve, and applying feedforward control over the closure of the valve, the second condition predictive of compressor surge.

2. The method of claim 1 wherein the feedback control includes control of the position of the valve as a sum of feedback terms, wherein the feedback terms depend on a difference between current and set-point dilution levels of the intake-air charge or of an air-to-fuel ratio of the exhaust.

3. The method of claim 2 wherein the feedback terms include a term proportional to the difference and a term proportional to the difference integrated over time.

4. The method of claim 3 wherein the feedforward control includes control of the position of the valve as a function of the set-point dilution level of the intake air charge or the set-point air-to-fuel ratio, irrespective of the current dilution level or current air-to-fuel ratio.

5. The method of claim 3 further comprising:
on transitioning from the first condition to the second condition, freezing one or more of the feedback terms as computed prior to the transitioning; and
applying the feedforward control to adjust the valve position resulting from the feedback control with feedback terms frozen.

6. The method of claim 1 wherein the exhaust is drawn from downstream of a turbine and admitted upstream of a compressor.

7. The method of claim 1 wherein the valve is less open during the second condition than during the first condition.

8. The method of claim 1 wherein external exhaust-gas recirculation is enabled during the first condition and disabled during the second condition.

9. An engine system comprising:
an air intake;
an air compressor coupled to the air intake and configured to deliver a boosted intake-air charge to a combustion chamber;
an exhaust conduit to receive exhaust from the combustion chamber;
an electronically controlled valve coupled between the exhaust conduit and the air intake to adjustably admit the exhaust to the air intake; and
a controller configured to apply at least some feedback control over opening and closure of the valve during a first condition, and, during a second condition, to apply no feedback control over the opening or the closure of the valve but to apply feedforward control over the closure of the valve, the second condition predictive of compressor surge.

10. The system of claim 9 further comprising a pedal-position sensor and a boost-pressure sensor operatively coupled to the controller, wherein a combined output of the pedal-position sensor and the boost-pressure sensor does not predict compressor surge during the first condition but does predict compressor surge during the second condition.

11. The system of claim 9 further comprising, operatively coupled to the controller, an intake-air dilution sensor or an exhaust air-to-fuel ratio sensor, wherein the feedback control is based on an output of the sensor.

12. The system of claim 9 further comprising an exhaust-powered turbine mechanically coupled to a compressor, wherein the exhaust conduit is coupled downstream of the turbine and the air intake is coupled upstream of the compressor.

13. The system of claim 12 further comprising a compressor recirculationvalve (CRV) coupled between an inlet and an outlet of the compressor, wherein the CRV is held closed during the second condition.

14. The system of claim 12 further comprising a wastegate coupled between an inlet and an outlet of the turbine, wherein the wastegate is held closed during the second condition.

15. A method to avoid over-dilution of an intake-air charge of an engine, the method comprising:
receiving first data responsive to a boost pressure of a compressor coupled to an air intake of the engine;
receiving second data responsive to a set-point mass flow rate of air through the compressor;
determining whether the first and second data lie outside or within a predicted surge region of the compressor;
if the first and second data lie outside the surge region of the compressor, applying at least some feedback control over opening and closure of a valve that adjustably admits exhaust to the air intake; but
if the first and second data lie within the surge region of the compressor, applying no feedback control over the opening or the closure of the valve, and applying feedforward control over the closure of the valve.

16. The method of claim 15 wherein the first data is received from a boost-pressure sensor coupled to an intake manifold of the engine.

17. The method of claim 15 wherein the second data is received from an accelerator-pedal position sensor of a vehicle in which the engine is installed.

18. The method of claim 15 further comprising receiving third data from an intake-air dilution sensor or an exhaust air-to-fuel ratio sensor, wherein the feedback control is based on an output of the sensor.

19. The method of claim 15 wherein the feedback control includes control of a position of the valve as a sum of feedback terms, wherein the feedback terms depend on a difference between current and set-point dilution levels of the intake-air charge or of an air-to-fuel ratio of the exhaust.

20. The method of claim 15 wherein the feedforward control includes control of a position of the valve as a function of the set-point dilution level of the intake air charge or the set-point air-to-fuel ratio, irrespective of the current dilution level or current air-to-fuel ratio.
